(19) United States
(12) Patent Application Publication
(10) Pub. No.: US 2007/0297546 A1
(43) Pub. Date: Dec. 27, 2007

(54) SIGNAL SYNCHRONIZATION SYSTEM

(75) Inventor: Chung-Li Shen, Taipei (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: BEYOND INNOVATION TECHNOLOGY CO., LTD., Taipei (TW)

(21) Appl. No.: 11/559,418

(22) Filed: Nov. 14, 2006

(30) Foreign Application Priority Data
Jun. 22, 2006 (TW) 95122459

(51) Int. Cl. H04L 7/00

(52) U.S. Cl. 375/354

(57) ABSTRACT

The invention provides signal synchronization systems. The signal synchronization system comprises a plurality of synchronization units and a control unit. The synchronization units each correspond to one transmitting device for accurately transmitting the transmitted data from the transmitting devices to the control unit. The control unit generates a system clock and a data selection signal according to the amount of the transmitting devices. The system clock has to be fast enough to be capable of receiving data from all transmitting devices. The transmitted data is transmitted to the control unit according to the order shown in the data selection signal. The control unit integrates the received data in a single signal named system data signal and further generates a data selection signal to designate a plurality of receiving devices to receive the data in the system data signal. The transmitted data can be accurately transmitted from the transmitting devices to the receiving devices by the signal synchronization system of the invention.

### BACKGROUND OF THE INVENTION

1. Field of the Invention

The invention relates to signal synchronization, and in particular to signal synchronization systems for accurately transmitting data from a plurality of transmitting devices to a plurality of receiving devices.

2. Description of the Related Art

Signal synchronization is critically important in electronic devices. For signal transmission, such as multimedia transmission over networks or image transmission in electronic systems, signal synchronization is important to accurately transmit data from transmitting devices to receiving devices.

Quartz oscillators arc used in conventional signal synchronization to generate a base-clock for a system. Based on the base-clock, a plurality of frequency dividers and phase-locked loops generate other clocks at various frequencies for devices in the system. The clocks generated by the phase-locked loops, however, always contain noise. These clocks are therefore inaccurate, and the transmitting and receiving devices working on these clocks are incapable of transmitting data accurately.

FIG. 1 shows a conventional signal synchronization system 102, transmitting data from a plurality of transmitting devices 10a to 10n to a plurality of receiving devices 11a to 11z. Signals from the transmitting devices 10a to 10n are, respectively, S1 to Sn, each comprising data and synchronization messages. The working clocks of the transmitting devices 10a to 10n are Clock1 to Clock n, respectively. The signals S1 to Sn and the clocks Clock1 to Clockn are all transmitted to the conventional signal synchronization system 102. To accurately transmit the data contained in the signals S1 to Sn, the conventional signal synchronization system 102 generates working clocks ClockA to ClockZ and signals SA to Sz for the receiving devices, respectively. The data from the transmitting devices 10a to 10n is rearranged in the signals SA to SZ. Based on the respective working clocks ClockA to ClockZ, the receiving devices 11a to 11z can accurately receive data carried by the respective signals SA to SZ according to the synchronization messages contained in the respective signals SA to SZ.

As shown in FIG. 1, however, it is necessary to set exclusive pins for each receiving devices 11a to 11z. The complexity of the circuit of the conventional signal synchronization system 102 increases with the increasing amount of receiving devices. Signal synchronization providing reduced package and PCB layout cost is thus called for.

### BRIEF SUMMARY OF THE INVENTION

The invention provides signal synchronization systems for synchronously transmitting data from a plurality of transmitting devices to a plurality of receiving devices. The invention further reduces the pin count of the signal synchronization chip to optimize circuit layout and reduce package cost.

The signal synchronization system of the invention comprises a plurality of synchronization units and a control unit. Each transmitting device corresponds to one synchronization unit. The control unit generates a system clock and a data selection signal. The data selection signal determines which synchronization unit performs signal synchronization. Based on the system clock, the data selection signal and signals from the transmitting devices, the synchronization units synchronize the corresponding transmitting device and the control unit. The synchronized signals are transmitted to the control unit. Based on the system clock and the signals transmitted from the synchronization units, the control unit generates an output selection signal. Based on the system clock and the output selection signal, the control unit directs the receiving devices to receive the data of synchronized signals. The receiving devices synchronously receive the data from the transmitting devices.

The signal synchronization system of the invention can be further implemented in transmitting bitstream signals from a plurality if transmitting devices.

The signal synchronization system can be further utilized in other applications, such as transmitting data from a plurality of transmitting devices to a single receiving device, or transmitting data from a plurality of transmitting devices to a plurality of receiving devices.

### BRIEF DESCRIPTION OF THE DRAWINGS

The invention can be more fully understood by reading the subsequent detailed description and examples with references made to the accompanying drawings, wherein:

FIG. 1 shows a conventional signal synchronization system;

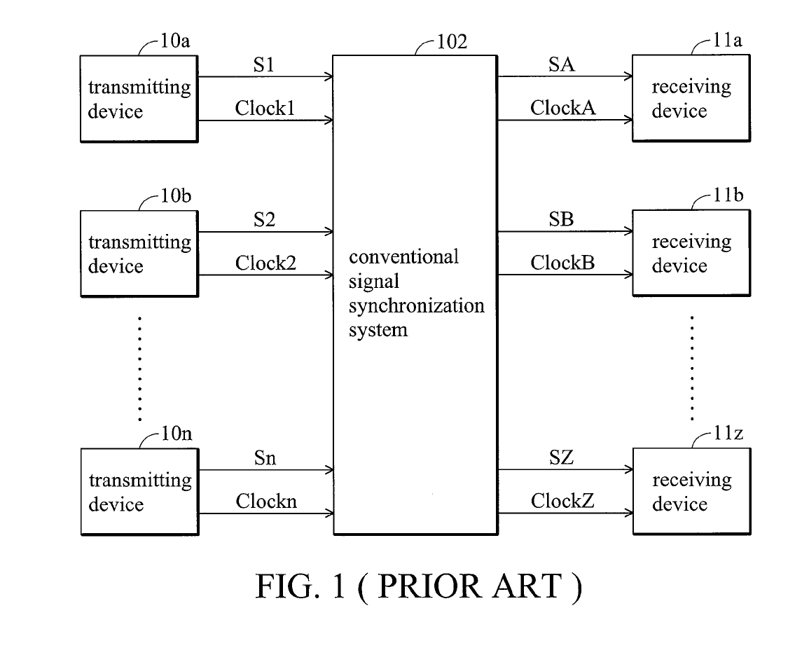

FIG. 2 shows an embodiment of a signal synchronization system of the invention;

FIG. 3 shows another embodiment of the invention;

FIG. 4 shows another embodiment of the invention;

FIG. 5 shows another embodiment of the invention which synchronously transmits bitstream signals from transmitting devices to receiving devices;

FIG. 6 illustrates a portion of the system synchronization system shown in FIG. 4;

FIG. 7 is a timing diagram of the relationship between the signals output from the signal synchronization system of FIG. 4;

FIG. 8 shows another embodiment of the invention, which transmits image data from a plurality of transmitting devices to a single receiving device;

FIG. 9 shows another embodiment of the invention, which transmits bitstream signals from a plurality of transmitting devices to a single receiving device;

FIG. 10 shows an embodiment of a synchronization unit;

FIG. 11 illustrates measurement of the synchronization differences Vph_A and Vph_B;

FIG. 12 shows another embodiment of a synchronization unit;

FIG. 13 illustrates measurement of the synchronization differences Hph_A and Hph_B.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

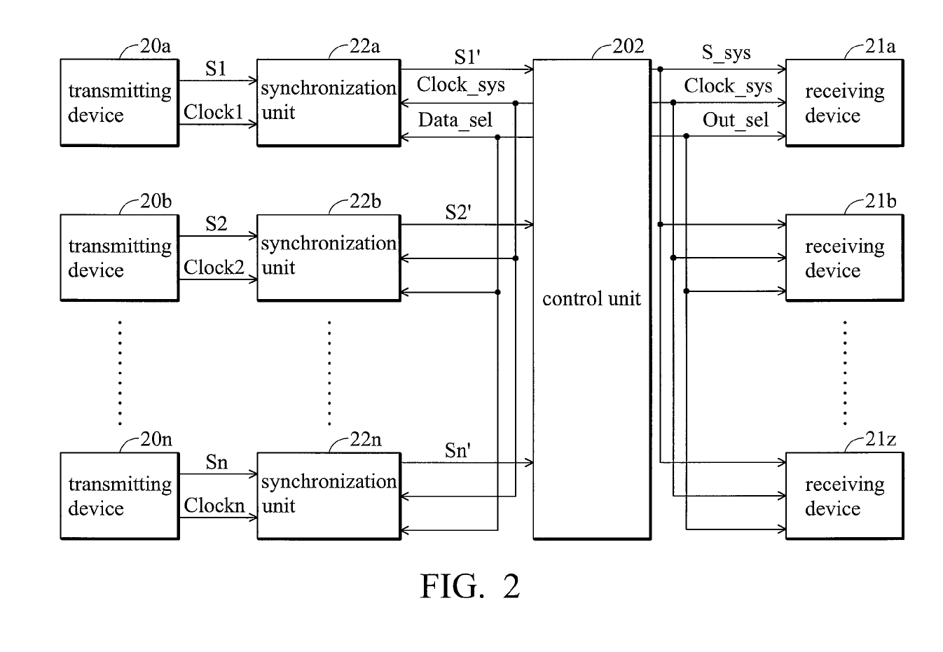

FIG. 2 shows an embodiment of a signal synchronization system of the invention, which transmits data from a plurality of transmitting devices to a plurality of receiving devices. The signal synchronization system comprises a plurality of synchronization units 22a to 22n, and a control unit 202. The synchronization units 22a to 22n correspond to transmitting devices 20a to 20n, respectively. The total amount of the transmitting devices 20a to 20n is n. The working clocks of the transmitting devices 20a to 20n are Clock1 to Clockn, respectively. Based on the total amount of the transmitting devices (n) and the clocks Clock1 to Clockn, the control unit 202 generates a system clock Clock_sys and a data selection signal Data_sel. With the system clock Clock_sys, the control unit 202 receives data according to the order shown in the data selection signal Data_sel. The content of the data selection signal Data_sel is according to the number of the transmitting devices 20a to 20n. For example, when the amount of the transmitting devices is 2 (n=2), and the frequency of Clock1 and Clock2 are 66 MHz, the system clock Clock_sys may be set as 132 MHz. The data selection signal Data_sel continuously changes between the number “1” and the number “2” according to the system clock Clock_sys.

The synchronization units 22a to 22n perform signal synchronization according to the corresponding signals S1 to Sn, the system clock Clock_sys and the data selection signal Data_sel. The signals S1 to Sn from the transmitting devices are synchronized as signals S1′ to Sn′ by the synchronization units 22a to 22n.

The control unit 202 receives the synchronized signals S1′ to Sn′ to generate a system signal S_sys. The control unit 202 further generates an output selection signal Out_sel according to the synchronized signals S1′ to Sn′ and the system clock Clock_sys. With the system clock Clock_sys, the control unit 202 designates the receiving devices 21a to 21z to receive the data transmitted in the system signal S_sys according to the output selection signal Out_sel. The data selection signal Data_sel and the output selection signal Out_sel can be realized as pulse signals or bitstream signals.

As shown in FIG. 2, the system clock Clock_sys is provided by the control unit 202. Since the signal synchronization performed by the synchronization units 22a to 22n and the signal transmission from the control unit 202 to the receiving devices 21a to 21z are all operated with the system clock Clock_sys, synchronous data transmission from the transmitting devices (20a to 20n) to the receiving devices (21a to 21z) is available. The signal synchronization system 202 of the invention requires fewer pins than the conventional signal synchronization system 102.

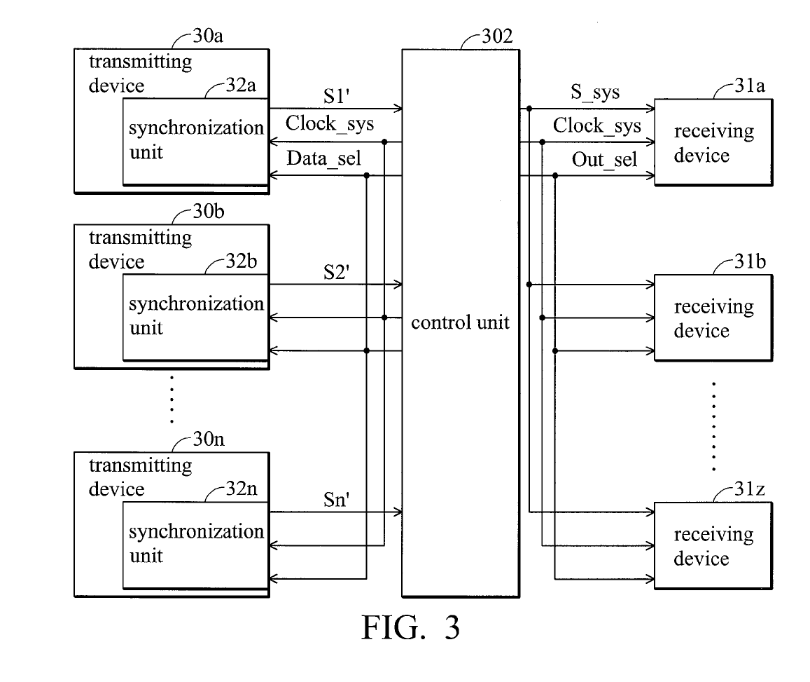

FIG. 3 shows another embodiment of the invention. The synchronization units 32a to 32n are embedded in the corresponding transmitting devices 30a to 30n. The functions of the synchronization units 32a to 32n and the control unit 302 are similar to those in FIG. 2. The transmitting devices 30a to 30n and the receiving devices 31a to 31z are synchronized via the synchronization units 32a to 32n and the control unit 302.

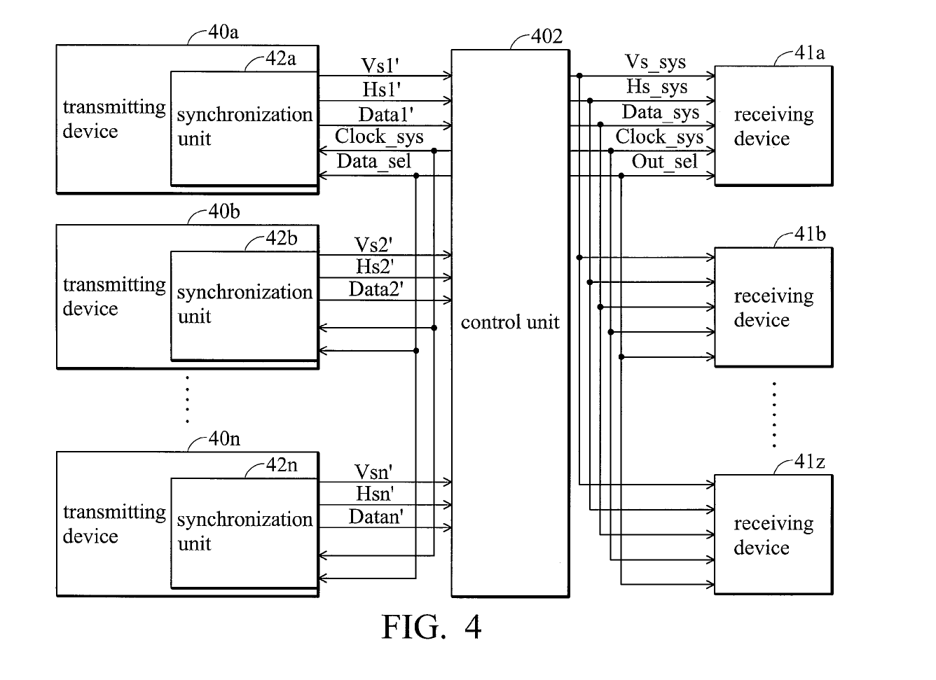

FIG. 4 shows another embodiment of the invention. The transmitting devices (40a to 40n) each output a vertical synchronization signal (not shown), a horizontal synchronization signal (not shown), and a data signal (not shown). The signals from the transmitting devices 40a to 40n are received by the corresponding synchronization units 42a to 42n to generate synchronized vertical synchronization signals Vs1′ to Vsn′, horizontal synchronization signals Hs1′ to Hsn′, and data signals Data1′ to Datan′.

The control unit 402 generates a system clock Clock_sys and a data selection signal Data_sel for the transmitting devices. Based on the system clock Clock_sys and a data selection signal Data_sel, the synchronization units 42a to 42n perform signal synchronization. After receiving the synchronized signals comprising the vertical synchronization signals Vs1′ to Vsn′, the horizontal synchronization signals Hs1′ to Hsn′, and the data signals Data1′ to Datan′, the control unit 402 generates a system vertical synchronization signal Vs_sys, a system horizontal synchronization signal Hs_sys, and a system data signal Data_sys. The control unit 402 further generates an output selection signal Out_sel for the receiving devices 41a to 41z. Based on the system clock Clock_sys, the system vertical synchronization signal Vs_sys, and the system horizontal synchronization signal Hs_sys, the output selection signal Out_sel designates the receiving devices 41a to 41z to receive the data carried in the system data signal Data_sys.

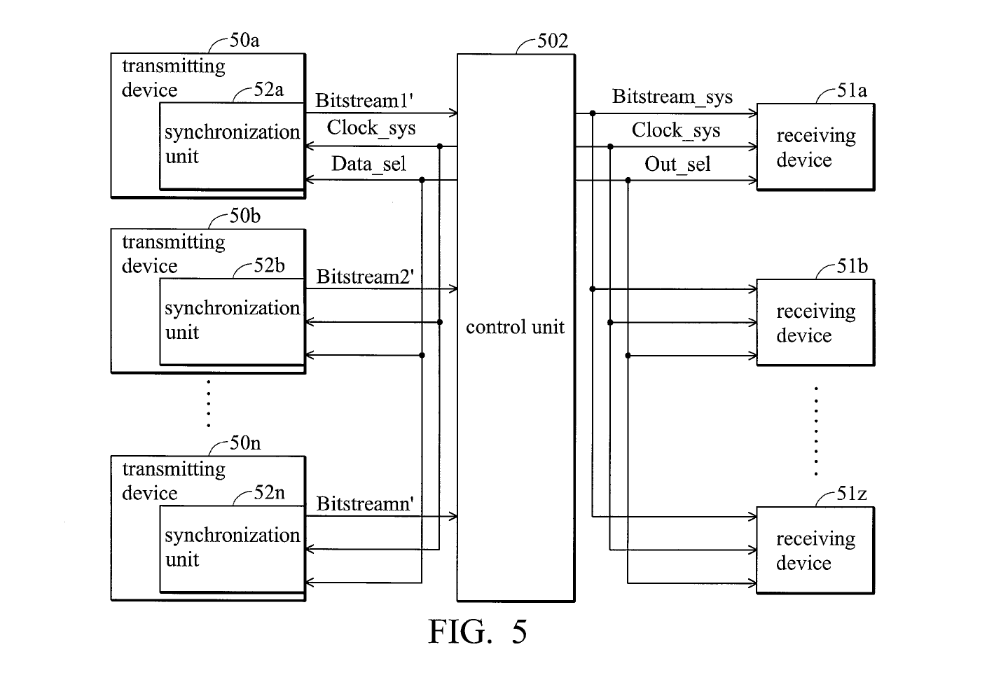

FIG. 5 shows another embodiment of the invention which synchronously transmits bitstream signals from transmitting devices to receiving devices. The signals from transmitting devices 50a to 50n are bitstream signals (not shown), received by corresponding synchronization units (52a to 52n) to generate synchronized bitstream signals Bitstream1′ to Bitstreamn′. A control unit 502 receives the synchronized bitstreams signals (Bitstream1′ to Bitstreamn′) to generate a system bitstream Bitstream_sys.

The control unit 502 generates a system clock Clock_sys and a data selection signal Data_sel for the transmitting devices The synchronization units 52a to 52n performs signal synchronization according to the system clock Clock_sys and the data selection signal Data_sel. The control unit 502 further generates an output selection signal Out_sel for the receiving devices 41a to 41z. Based on the system clock Clock_sys and the synchronization message contained in the system bitstream Bitstram_sys, the output selection signal Out_sel designates the receiving devices 51a to 51z to receive the data carried in the system bitstream signal Bitstream_sys.

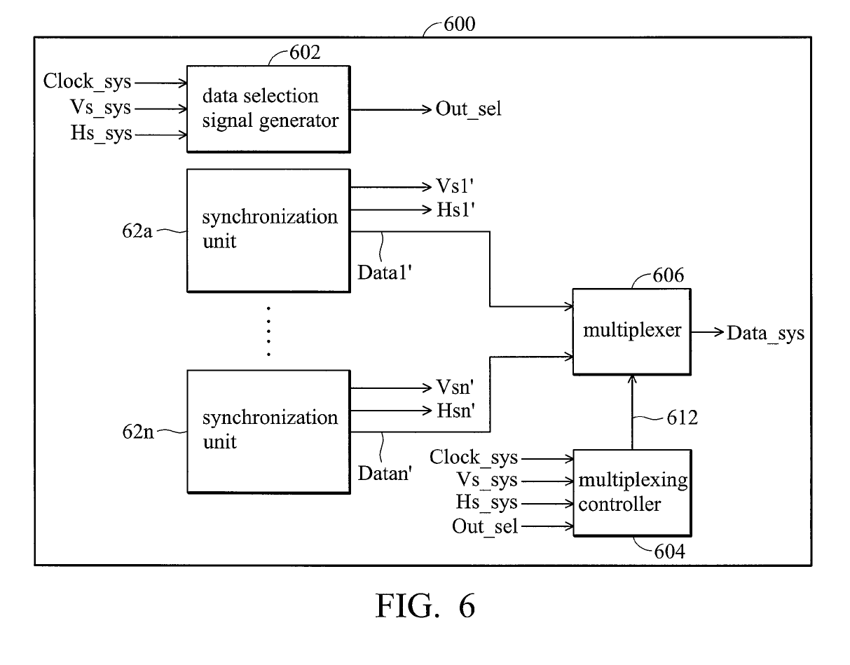

FIG. 6 illustrates a portion of the system synchronization system shown in FIG. 4. A signal synchronization system 600 comprises a plurality of synchronization units 62a to 62n, a data selection signal generator 602, a multiplexer 606, and a multiplexing controller 604. As shown in FIG. 4, The control unit 402 generates a system vertical synchronization signal Vs_sys, a system horizontal synchronization signal Hs sys according to the vertical synchronization signals Vs1′ to Vsn′ and the horizontal synchronization signals Hs′ to Hsn′. The data selection signal generator 602 generates the output selection signal Out_sel according to the system clock Clock_sys, the system vertical synchronization signal Vs_sys and the system horizontal synchronization signal Hs_sys. Based on the system clock Clock_sys, the system vertical synchronization signal Vs_sys, the system horizontal synchronization signal Hs_sys and the output selection signal Out_sel, the multiplexing controller 604 generates a multiplexing control signal 612 controlling the multiplexer 606 to generate a system data signal Data_sys in which the data contained in the data signals Data1′ to Datan′ is combined. The receiving devices 41a to 41z are designated to receive the data contained in the system data signal Data_sys according to the output selection signal Out_sel.

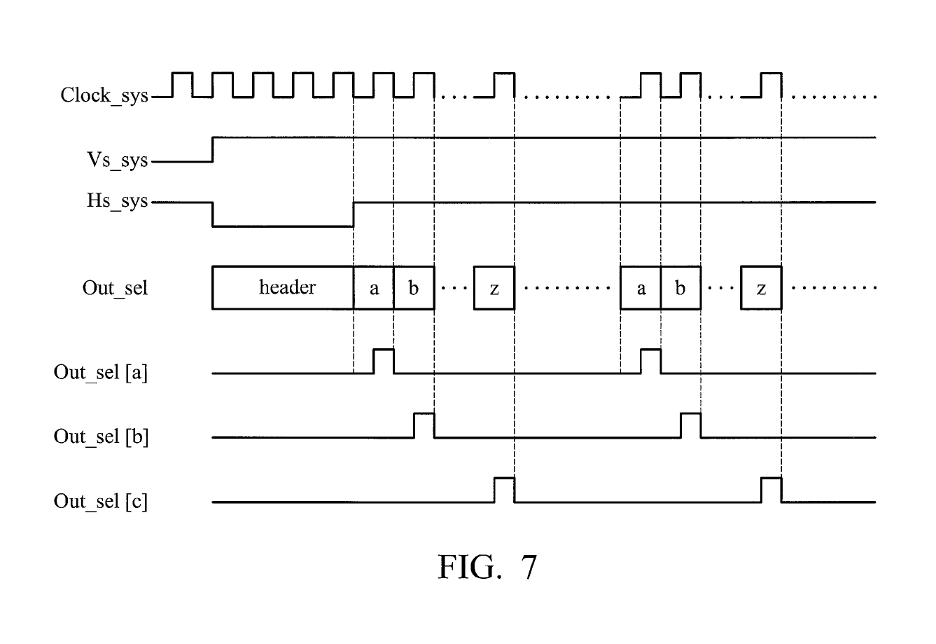

FIG. 7 is a timing diagram of the relationship between the signals output from the signal synchronization system of FIG. 4. As shown in FIG. 4, based on the system clock Clock_sys, the system vertical synchronization signal Vs_sys and the system horizontal synchronization signal Hs_sys, the output selection signal Out_sel designates the receiving devices 41a to 41z to receive the data in the system data signal Data_sys. The output selection signal Out_sel may comprise a plurality of pulse signals, Out_sel[a] to Out_sel[z] (shown in FIG. 7), to trigger the corresponding receiving devices 41a to 41z to receive the data carried in the system data signal Data_sys. In another embodiment, the output selection signal Out_sel may be realized as a bitstream signal (shown as Out_sel in FIG. 7). The information following the header of the bitstream signal Out_sel triggers the receiving devices (41a to 41z) to receive the data in the system data signal Data_sys. As shown by the output selection signal Out_sel of FIG. 7, ‘a’ indicates that the data contained in the system data signal Data_sys has to be received by the receiving device 41a.

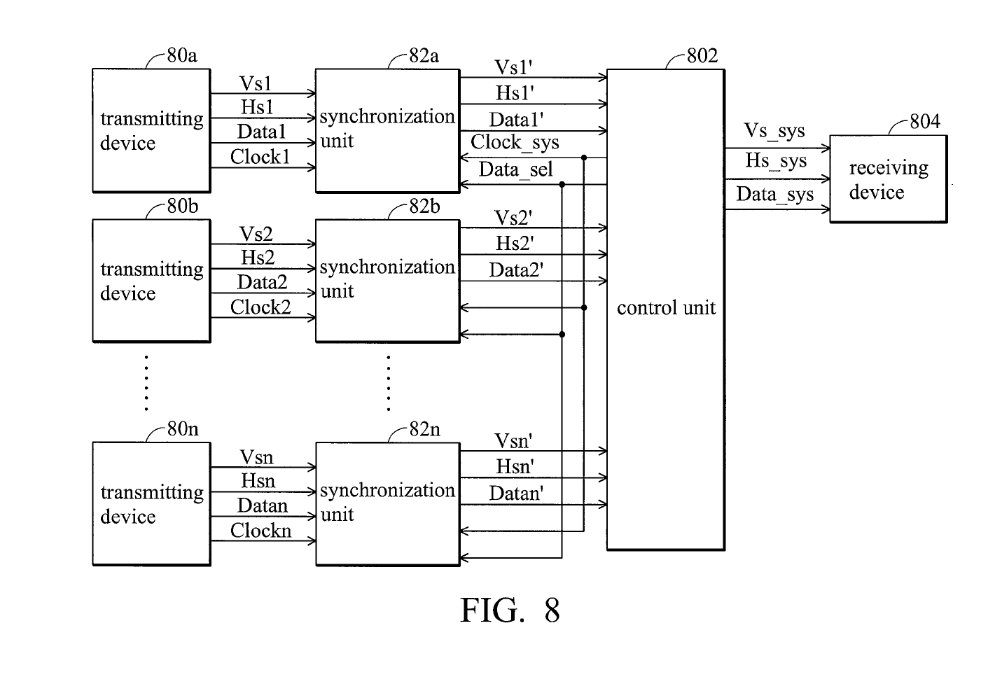

FIG. 8 shows another embodiment of the invention, which transmits image data from a plurality of transmitting devices (80a to 80n) to a single receiving device (804). A control unit 802 generates a system clock Clock_sys and a data selection signal Data_sel to provide enough bandwidth to transmit the data from the transmitting devices 80a to 80n. According to the system clock Clock_sys and the data selection signal Data_sel, a plurality of synchronization units 82a to 82n perform signal synchronization for accurate transmission of data from the transmitting devices (80a to 80n) to the control unit 802. As an example, based on signals from the transmitting device 80a (comprising a vertical synchronization signal Vs1′, a horizontal synchronization signal Hs1, a data signal Data1 and a clock signal Clock1) and the system clock signal Clock_sys and the data selection signal Data_sel, the synchronization unit 82a generates synchronized signals comprising a vertical synchronization signal Vs1′, a horizontal synchronization signal Hs1′ and a data signal Data1′. The control unit 802 can accurately receive data in the data signal Data1 by reading the data signal Dada1′ according to the vertical and horizontal synchronization signals Vs1′ and Hs1′ and the system clock Clock_sys. After receiving the transmitted data via the synchronization units (82a to 82), the control unit 802 generates a system vertical synchronization signal Vs_sys, a system horizontal signal Hs_sys and a system data signal Data_sys. The receiving device 804 can accurately receive data from the transmitting devices 80a to 80n by reading the system data signal Data_sys according to the synchronization signals Vs_sys and Hs_sys.

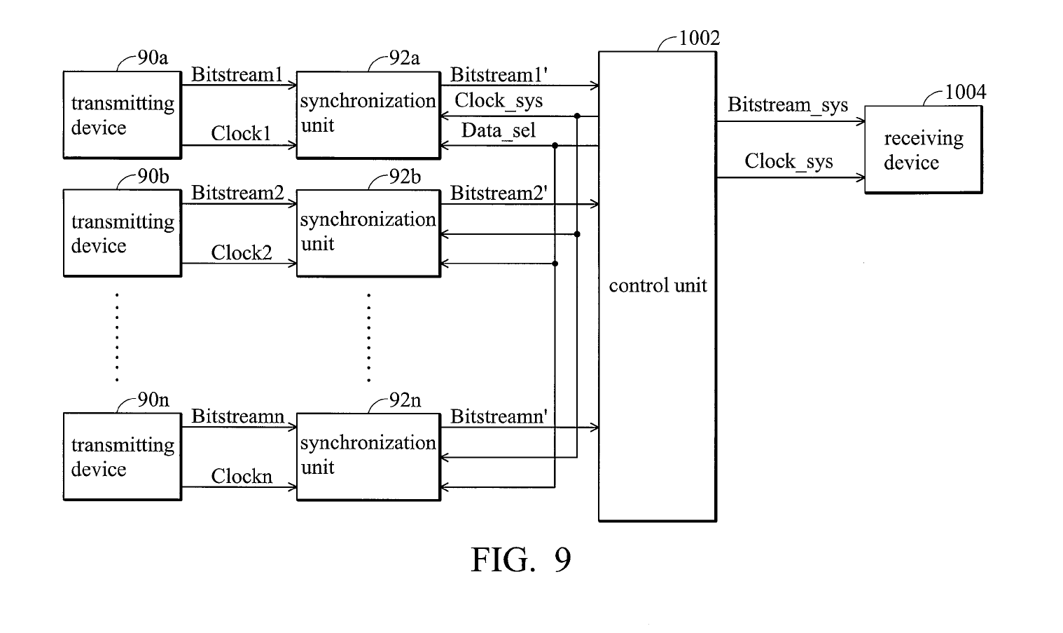

FIG. 9 shows another embodiment of the invention, which transmits image data from a plurality of transmitting devices (90a to 90n) to a single receiving device (1004). Signal transmission between the transmitting devices 90a to 90n, the signal synchronization system (comprising a plurality of synchronization units 92a to 92n and a control unit 1002) and the receiving device 1004 is similar to that shown in FIG. 8 differing here in that the transmitted data and the synchronization message are combined in bitstream format.

The signal synchronization system if the invention can be further applied in other applications, such as transmitting data from a plurality of transmitting devices to a plurality of receiving devices, wherein the amount of transmitting devices is equivalent to the amount of receiving devices.

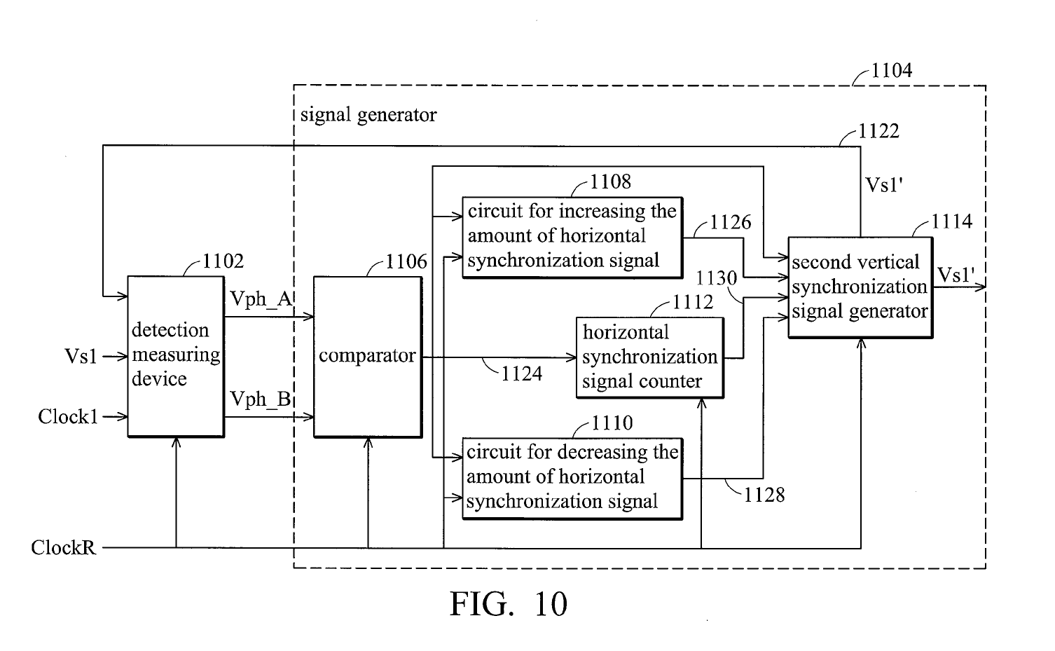

FIG. 10 shows an embodiment of a synchronization unit. A detection measuring device 1102 detects a phase difference between first and second vertical synchronization signals Vs1 and Vs1′. The second vertical synchronization signal Vs1′ is provided by a signal generator 1104. Based on the phase difference, synchronization differences Vph_A and Vph_B are measured. A comparator 1106 compares the synchronization differences Vph_A and Vph_B with the previous synchronization differences to detect the variations in the synchronization differences. Based thereon, an argument 1124 is generated. A circuit 1108 increasing the amount of horizontal synchronization signals generates a positive horizontal synchronization signal 1126 according to the argument 1124. Based on the positive horizontal synchronization signal 1126, the length of the invalid part of the second vertical synchronization signal Vs1′ is increased by an integer ClockR, where ClockR reads the second vertical synchronization signals Vs1′. A circuit 1110 for decreasing the amount of horizontal synchronization signals generates a negative horizontal synchronization signal 1128 according to the argument 1124. Based on the negative horizontal synchronization signal 1128, the length of the invalid part of the second vertical synchronization signal Vs1′ is decreased by an integer ClockR. A horizontal synchronization signal counter 1112 generates a counting result 1130 less than one ClockR. Based on the argument 1124, the positive horizontal synchronization signal 1126, the negative horizontal synchronization signal 1128, and the counting result 1130, a second vertical synchronization signal generator 1114 modifies the length of the invalid part of the second vertical synchronization signal Vs1′.

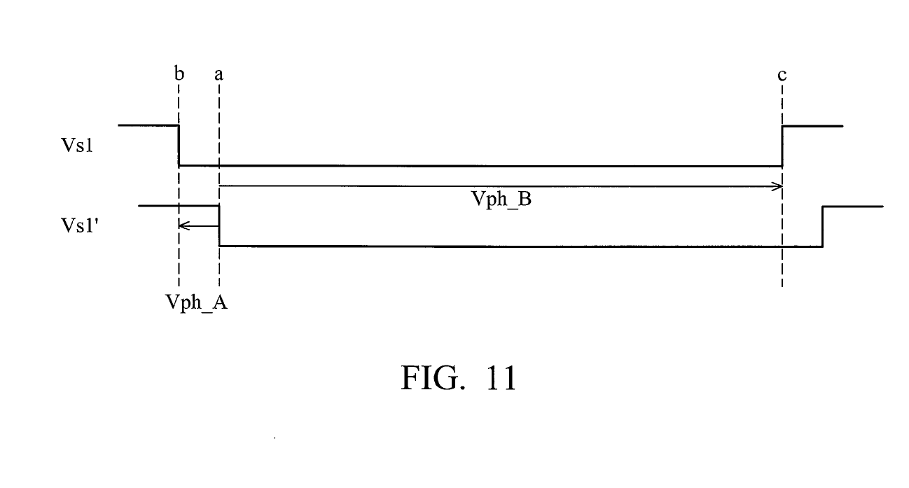

FIG. 11 illustrates measurement of the synchronization differences Vph_A and Vph_B. ‘a’ is the starting point of the invalid part of the second vertical synchronization signal Vs1′. ‘b’ is the starting point of the invalid part of the first vertical synchronization signal Vs1. ‘c’ is the ending point of the invalid part of the first vertical synchronization signal Vs1. The phase difference from ‘a’ to ‘b’ is the synchronization difference Vph_A. The phase difference from ‘a’ to ‘c’ is the synchronization difference Vph_B.

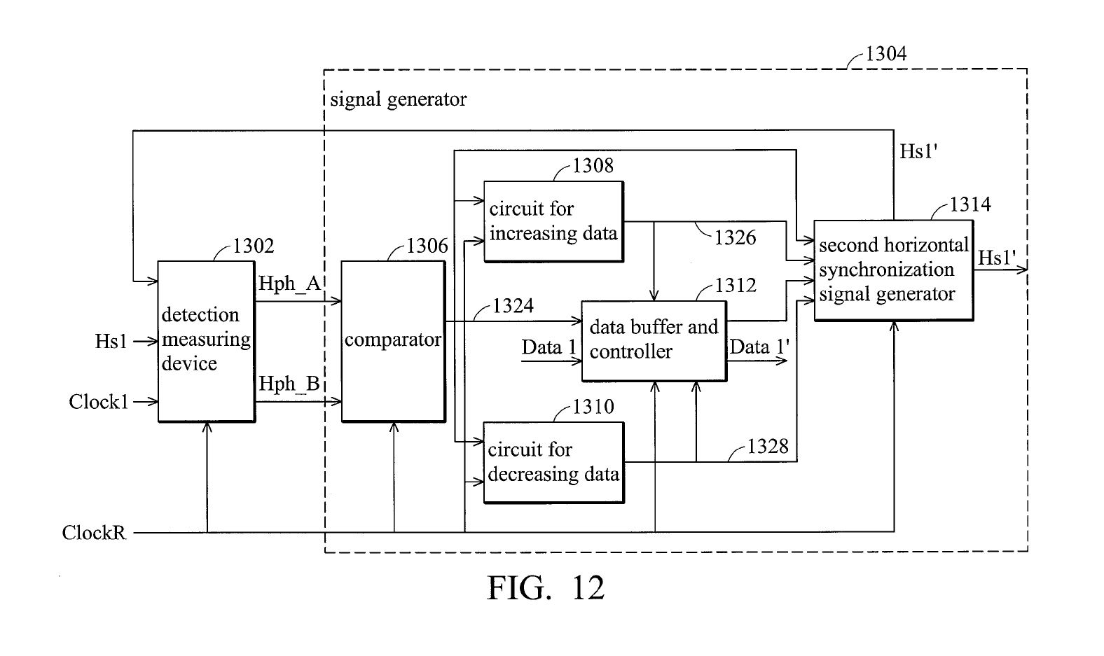

FIG. 12 shows another embodiment of a synchronization unit. A detection measuring device 1302 detects a phase difference between first and second horizontal synchronization signals Hs1 and Hs1′. The second vertical synchronization signal Hs1′ is provided by a signal generator 1304. Based on the phase difference, synchronization differences Hph_A and Hph_B are measured. A comparator 1306 compares the synchronization differences Hph_A and Hph_B with the previous synchronization differences to detect the variations thereof. Based the variations, an argument 1324 is generated. A circuit 1308 for increasing data generates a positive data signal 1326 according to the argument 1324. Based on the positive data signal 1326, the length of the invalid part of the second horizontal synchronization signal Hs1′ is increased. A circuit 1310 for decreasing data generates a negative data signal 1328 according to the argument 1324. Based on the negative data signal 1328, the length of the invalid part of the second horizontal synchronization signal Hs1′ is decreased. Based on the argument 1324, the positive data signal 1326 and the negative data signal 1328, a data buffer and controller 1312 modifies the length of the invalid part of first data signal Data1 to generate second data signal Data1′. Based on the argument 1324, the positive data signal 1326, the negative data signal 1328 and the second data signal Data1′, a second horizontal synchronization signal generator 1314 modifies the length of the invalid part of the second horizontal synchronization signal Hs1′.

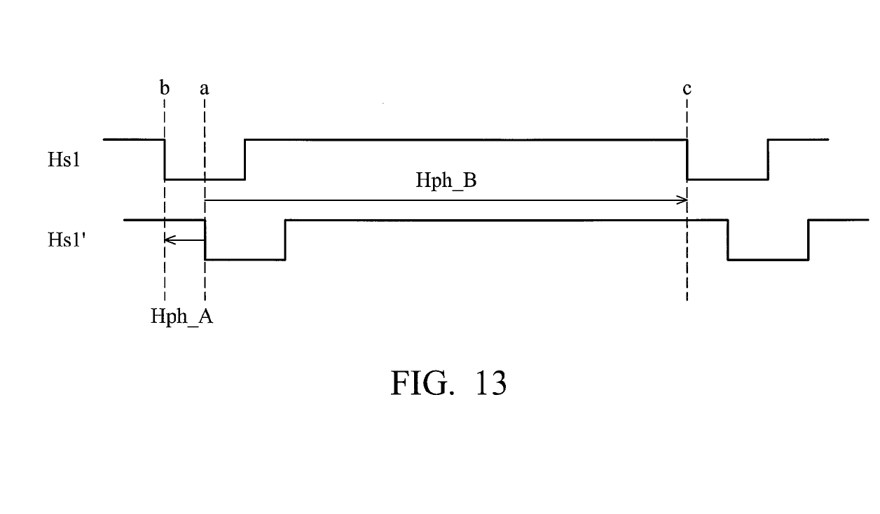

FIG. 13 illustrates measurement of the synchronization differences Hph_A and Hph_B. ‘a’ is the starting point of the invalid part of the second horizontal synchronization signal Hs1′. ‘b’ is the starting point of the invalid part of the first horizontal synchronization signal Hs1. ‘c’ is the ending point of the valid part of the first vertical synchronization signal Hs1. The phase difference from ‘a’ to ‘b’ is the synchronization difference Hph_A. The phase difference from ‘a’ to ‘c’ is the synchronization difference Hph_B.

The synchronization unit of the invention may be implemented in other ways which modify the signals from a transmitting device for accurate data transmission.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded to the broadest interpretation so as to encompass all such modifications and similar arrangements.

What is claimed is:

1. A signal synchronization system, comprising:
at last a transmitting device, transmitting a output;
at last a synchronization unit, receiving the output and synchronizing the output according to a system clock, the synchronization unit transmitting the synchronized output;
a control unit, providing the system clock and controlling to receive the synchronized output from the synchronization unit and transmit a data of the synchronized output; and
at last a receiving device, using the system clock, and receiving the data.

2. The signal synchronization system as claimed in claim 1, wherein the system comprises a plurality of transmitting devices and a plurality of corresponding synchronization units and wherein the control unit utilizes a data selection signal to control to receive the synchronized outputs from the synchronization units.

3. The signal synchronization system as claimed in claim 1, wherein the system comprises a plurality of receiving device wherein the control unit utilizes a output selection signal to control these receiving devices to receive the synchronized outputs from the control unit.

4. The signal synchronization system as claimed in claim 1, wherein the output of transmitting device comprises a first clock, a first synchronization signal and a first data signal, and the synchronized output of synchronization unit comprises a second synchronization signal and a second data signal.

5. The signal synchronization system as claimed in claim 4, wherein the synchronization unit comprises:
a detection measuring device, generating a synchronization difference according to the first clock, the first synchronization signal and the second synchronization signal; and
a signal generator, modifying the length of the second synchronization signal according to the synchronization difference, wherein the signal generator generates the second synchronization signal based on the system clock.

6. The signal synchronization system as claimed in claim 5, wherein the first synchronization signal comprises a first horizontal synchronization signal and a first vertical synchronization signal, and the second synchronization signal comprises a second horizontal synchronization signal and a second vertical synchronization signal.

7. The signal synchronization system as claimed in claim 6, wherein the detection measuring device detects the first clock, the system clock, the first vertical synchronization signal and the second vertical synchronization signal, and the signal generator modifies the interval duration of second vertical synchronization signal by adjusting the amount or the length of second horizontal synchronization signals during the interval of second vertical synchronization signal.

8. The signal synchronization system as claimed in claim 7, wherein the signal generator comprises:
a comparator, generating an argument according to the synchronization difference;
a circuit for increasing the amount of horizontal synchronization signal, generating a positive horizontal synchronization signal according to the argument;
a circuit for decreasing the amount of horizontal synchronization signals, generating a negative horizontal synchronization signal according to the argument;
a horizontal synchronization signal counter, generating a counting result according to the argument; and
a second vertical synchronization signal generator, generating the second vertical synchronization signal based on the argument, the positive horizontal synchronization signal, the negative horizontal synchronization signal, and the counting result.

9. The signal synchronization system as claimed in claim 6, wherein the detection measuring device detects the first clock, the system clock, the first horizontal synchronization signal and the second horizontal synchronization signal, and the signal generator modifies the interval duration of second horizontal synchronization signal by adjusting the length of first data signal or adjusting the length of second horizontal synchronization signal during the interval of second horizontal synchronization signal.

10. The signal synchronization system as claimed in claim 9, wherein the signal generator comprises:
a comparator, generating an argument according to the synchronization difference;
a circuit for increasing data, generating a positive data signal according to the argument;
a circuit for decreasing data, generating a negative data signal according to the argument;
a data buffer and controller, generating the second data signal by modifying the first data signal according to the argument, the data transmitted from the corresponding transmitting device, the positive data signal and the negative data signal; and
a second horizontal synchronization signal generator, generating the second horizontal synchronization signal based on the argument, the positive data signal and the negative data signal.

11. The signal synchronization system as claimed in claim 1, wherein the output of transmitting device comprises a first clock and a first bitstream, and the output of synchronization unit comprises a second bitstream.

12. The signal synchronization system as claimed in claim 1, wherein the synchronization unit is built in the transmitting device.

13. The signal synchronization system as claimed in claim 2, wherein the control unit further comprises:
a data selection signal generator, generating the data selection signal based on the system clock and the synchronization signal of the synchronized output;
a multiplexing controller, generating a multiplexing control signal based on the system clock, the data selection signal and the synchronization signal of the synchronized output; and
a multiplexer, receiving the data of the synchronized output, and the multiplexer transmitting the data according to the multiplexing control signal.

14. The signal synchronization system as claimed in claim 2, wherein the data selection signal may be implemented as a type of a pulse signal or a bitstream signal.

15. The signal synchronization system as claimed in claim 3, wherein the output selection signal may be implemented as a plurality of pulse signals or a bitstream signal.

16. The signal synchronization system as claimed in claim 1, wherein the amount of transmitting device equal to the amount of receiving devices.
